(19) United States
(12) Patent Application Publication
(10) Pub. No.: US 2026/0337530 A1
(43) Pub. Date: Oct. 29, 2026

(54) BIODEGRADABLE LAUNDRY ARTICLE AND METHOD OF MAKING THE SAME

(71) Applicant: Everyone's Earth Inc., Ossining, NY (US)

(72) Inventors: Vladimiro Nettel, Ossining, NY (US); Thomas C. Kallish, Ossining, NY (US)

(21) Appl. No.: 19/656,623

(22) Filed: Apr. 23, 2026

Related U.S. Application Data
(60) Provisional application No. 63/793,229, filed on Apr. 23, 2025.

(51) Int. Cl. C11D 17/04; C11D 3/00; C11D 3/20; C11D 3/50; D04H 1/425; D06M 13/00; D06M 101/06

(52) U.S. Cl. CPC C11D 17/047; C11D 3/001; C11D 3/2006; C11D 3/50; D04H 1/425; D06M 13/005; D06M 2101/06; D06M 2200/50; D10B 2201/02; D10B 2401/12

(57) ABSTRACT

A biodegradable, disposable dryer sheet having a non-woven substrate made with 100% cotton and a biodegradable treatment composition applied to the substrate sheet. The treatment composition includes at least one a softening agent, an antistatic agent, a fragrance, and a binder. A method of manufacturing a disposable dryer sheet includes preparing a non-woven substrate comprising 100% cotton by a spunlacing process, preparing a bio-degradable treatment composition with at least one of a softening agent, an antistatic agent, an antiwrinkle agent, a fragrance, and a binder, applying the treatment composition to the non-woven substrate, and cutting the non-woven substrate into individual dryer sheet.

### FIELD OF THE INVENTION

The present invention relates to laundry articles, in particular, laundry dryer sheets, and the method of making the same. More particularly, the present invention relates to biodegradable, disposable dryer sheets that represent an eco-friendly biodegradable product.

### BACKGROUND OF THE INVENTION

The laundering process typically requires a first washing step with a laundry detergent and a subsequent drying step in a clothes dryer. Normally, a laundry detergent, for example powdered, liquid or in unitized dose form such as a tablet, is added to the laundry washing machine with the soiled clothing and cold, warm or hot water for the washing step, and then the wet fabrics are transferred over to a clothes dryer where a separate fabric softener/antistatic agent is added, for example as a dryer sheet.

Dryer sheets are commonly used in a dryer with a load of laundry for imparting anti-static properties, fabric softening properties, anti-wrinkling properties, and fragrance to the laundry during a drying cycle. In general, the dryer sheet includes a thin, nonwoven fabric substrate coated or impregnated with one or more compositions that may include an anti-static agent and/or fabric softening agent, and optionally, a fragrance. Dryer sheets are designed to be activated by the heat and tumbling action of a dryer. The heat causes the compositions coated or impregnated into the dryer sheet to release, which then spreads to the other items in the dryer. Dryer sheets are generally provided for single use and are discarded afterwards.

Due to the widespread use of disposable dryer sheets, large quantities of dryer sheets are used each year and disposal of these products presents a problem. Most of the commercially available disposable dryer sheets are made with plastic materials, which do not break down in the environment and resist biodegradation. The average plastic dryer sheet can take at least from 20 to 200 years to decompose.

A further difficulty associated with prior art disposable dryer sheets is that such products typically utilize added compositions made with chemicals that do not decompose easily and may also be toxic, causing rashes and allergies from using articles that have been dried with the dryer sheets.

There is a need for reducing the amount of non-biodegradable materials in a disposable dryer sheet. There is a particular need to replace polyester-based substrate sheets with a substrate comprised of biodegradable materials. There is further a need to replace laundry compositions coated or impregnated into the dryer sheets with those made of natural and/or biodegradable materials.

U.S. Pat. No. 7,947,644 discloses a dryer sheet that includes a nonwoven substrate made with a mixture of natural fiber and regenerated cellulose fiber, and a fabric conditioning agent. The '644 patent describes regenerated cellulose fibers as cellulose fibers formed by extrusion or spinning.

US20230399595 discloses a consumable, single use active agent containing dryer sheet. The dryer sheet is made with meltblown or spunbond filaments made with natural polymers, such as starch (and its derivative) and cellulose (and its derivatives).

WO2018184039 discloses a compostable dryer sheet having a nonwoven substrate made with 100% cellulose continuous filaments made by extrusion. The substrate is produced by multibonding by merged filaments, hydrogen bonding and physical intermingling of the filaments.

An issue with meltblown, extruded or spunbond cellulosic fibers, such as those disclosed in the above-mentioned applications, is that they do not degrade in all conditions. Accordingly, use of these materials in a natural fiber containing dryer sheet makes it difficult, if not impossible, for them to pass one or more biodegradability tests such as ASTM Test Method D5511 (anaerobic conditions), ASTM Test Method 5338 (aerobic conditions) or ISO CD Test Method 14855.

What is desired, therefore, are biodegradable dryer sheets that can degrade in conditions in which oxygen is, or is not, present, i.e., both aerobic and anaerobic conditions. What is also desired is a dryer sheet comprised entirely or substantially of biodegradable materials that are compostable and/or will degrade in a landfill. In particular, it is desired to have dryer sheets that are able to pass at least one of ASTM Test Method D5511, ASTM Test Method 5338, ASTM Test Method D6400, and ISO CD Test Method 14855. It is further desired that such dryer sheets contain softening, antistatic, fragrance and other agents made of natural and/or biodegradable materials.

### SUMMARY OF THE INVENTION

It is therefore an objective of the invention to provide a biodegradable dryer sheet that is comprised substantially of biodegradable materials that will degrade in a landfill and/or through composting.

It is further object of the invention that the biodegradable dryer sheets are comprised of materials that degrade with and without oxygen.

It is particularly an object of the invention to provide biodegradable dryer sheets that are able to pass at least one of ASTM Test Method D5511, ASTM Test Method 5338, ASTM Test Method D6400, and ISO CD Test Method 14855.

It is also an object of the invention to provide a biodegradable dryer sheet that is composed of 100% cotton fibers, and in particular, spunlaced 100% cotton fibers.

It is further an object of the invention to provide biodegradable dryer sheets that utilize softening, antistatic, antiwrinkle and/or fragrance compositions made of natural and/or biodegradable materials.

In order to overcome the deficiencies of the prior art and to achieve at least some of the objects and advantages listed, the invention comprises a disposable dryer sheet including a non-woven substrate comprising 100% cotton fibers and a treatment applied to the substrate comprising at least one compound selected from the group consisting of softening agents, antistastatic agents, antiwrinkle agents and fragrances.

In some embodiments, the treatment composition is applied to at least one of a top surface or the bottom surface of the substrate.

In certain embodiments, the treatment composition is impregnated into the substrate.

In some embodiments, the substrate includes a plurality of pores.

In some embodiments, the substrate consists of 100% cotton spunlaced fibers.

In certain embodiments, the substrate is essentially free from spunbond and meltblown fibers.

In some embodiments, the treatment composition is applied to the substrate at a weight ratio of about 1:1.

In some cases, the treatment composition includes at least one softening agent selected from the group consisting of biodegradable cationic surfactants, biodegradable fatty alcohols and mixtures thereof.

In some embodiments, the treatment composition further includes at least one biodegradable diluent.

In certain embodiments, the treatment composition further includes at least one biodegradable pH control agent.

In some cases, the treatment composition is essentially free of water.

In some embodiments, the treatment composition includes from about 20% to about 40% by weight of at least one cationic surfactant; from about 20% to about 30% by weight of at least one fatty alcohol; from about 25% to about 45% by weight of at least one diluent; and from about 5% to about 20% by weight of at least one fragrance.

In certain embodiments, the treatment composition includes from about 20% to about 40% by weight of at least one cationic surfactant; from about 20% to about 30% by weight of at least one fatty alcohol; and from about 25% to about 45% by weight of at least one diluent.

In some embodiments, the disposable dryer sheet passes at least one of ASTM 05511, ASTM 5338, and ASTM D6400.

In some embodiments, the treatment composition is a single-phase composition including a softener, an anti-static agent, an anti-wrinkle agent, a fragrance, and a binder, wherein the single-phase composition is applied to the non-woven substrate in a single step.

In some embodiments, the treatment composition is a two-phase composition including a first phase composition comprising a softener, an anti-static agent and an anti-wrinkle agent, and a second phase composition comprising a fragrance and a binder, wherein the first phase composition and the second phase composition are sequentially applied to the non-woven substrate, and wherein the first phase composition is applied to the substrate at a weight ratio of about 0.9:1 and the second phase composition is applied to the substrate at a weight ratio of about 0.1:1.

A method of manufacturing a disposable dryer sheet is also provided, including the steps of preparing a non-woven substrate comprising 100% cotton by a spunlacing process; preparing a bio-degradable treatment composition comprising at least one of a softening agent, an antistatic agent, an antiwrinkle agent and a fragrance; applying the treatment composition to the non-woven substrate; and cutting the non-woven substrate into individual dryer sheets.

In some embodiments, the treatment composition is a two-phase composition including a first phase composition with a softener, an anti-static agent and an anti-wrinkle agent, and a second phase composition with a fragrance and a binder; and the step of applying the treatment composition to the non-woven substrate includes the steps of applying the first phase composition to the non-woven substrate and curing the substrate, and applying the second phase composition to the non-woven substrate and curing the substrate.

In certain embodiments, the treatment composition is a single-phase composition including a softener, an anti-static agent, an anti-wrinkle agent, a fragrance and a binder, wherein the treatment composition is applied to the non-woven substrate in a single step.

Other objects of the invention and its particular features and advantages will become more apparent from consideration of the following detailed description.

### DETAILED DESCRIPTION OF THE INVENTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The term “about” or “approximately” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, the singular forms “a,” “an,” and “the” include plural referents unless the content clearly dictates otherwise.

A “fatty acid” is a carboxylic acid with a long aliphatic chain, which is either saturated or unsaturated. Most naturally occurring fatty acids have an unbranched chain of an even number of carbon atoms, from 4 to 28. Fatty acids are usually not found free in organisms, but instead within three main classes of esters: triglycerides, phospholipids, and cholesteryl esters. Within the context of this disclosure, a reference to a fatty acid may refer to either its free or ester form.

“Surfactants” as used herein refers to a broad category of compounds that lower the surface tension between two liquids, for example oil and water, between a gas and a liquid, or between a liquid and a solid. In some instances, they can act as an anti-microbial agent and/or a preservative.

As used herein the term “nonwoven” fabric or web means a web having a structure of individual fibers or threads which are interlaid, but not in an identifiable manner as in a knitted or woven fabric. Nonwoven fabrics or webs can be formed by various processes including, but not limited to, meltblowing processes, spunbonding processes, spunlacing processes and bonded carded web processes.

As used herein the term “spunbond fibers” refers to small diameter fibers of mechanically and/or eductively drawn polymeric material. Spunbond fibers are generally formed by extruding molten thermoplastic material as filaments from a plurality of fine capillaries of a spinneret with the diameter of the extruded filaments then being rapidly reduced. Examples of spunbond fibers and methods of making the same are described in, by way of example only, U.S. Pat. No. 4,340,563 to Appel et al., U.S. Pat. No. 5,382,400 to Pike et al., and U.S. Pat. No. 5,795,926 to Pike et al.; the entire content of the aforesaid patents is hereby incorporated by reference herein. Spunbond fibers are generally not tacky when they are deposited onto a collecting surface and are continuous.

As used herein the term “meltblown fibers” means fibers of polymeric material which are generally formed by extruding a molten thermoplastic material through a plurality of die capillaries as molten threads or filaments into converging high velocity air streams which attenuate the filaments of molten thermoplastic material to reduce their diameter. Thereafter, the meltblown fibers can be carried by the high velocity gas stream and are deposited on a collecting surface to form a web of randomly dispersed meltblown fibers. Meltblowing processes are disclosed in, by way of example only, in U.S. Pat. No. 5,271,883 to Timmons et al.; U.S. Pat. No. 5,160,746 to Dodge et al.; U.S. Pat. No. 4,526,733 to Lau; U.S. Pat. No. 5,652,048 to Haynes et al.; and U.S. Pat. No. 5,366,793 to Fitts et al.; the entire contents of the aforesaid patents are hereby incorporated by reference herein. Meltblown fibers are generally smaller than about 10 micrometers in average diameter and, unlike spunbond fibers, are generally tacky when deposited onto a collecting surface, thereby bonding to one another during the deposition step.

As used herein “spunlaced fibers” refers to those made by a process involving the cohesion and the interlacing of the elementary fibers with one another is by means of a plurality of jets of water under pressure passing through a moving fleece or cloth and causing the fibers to intermingle with one another. As an example, a process for the production of spunlaced nonwoven cloths has been described in U.S. Pat. Nos. 3,214,819, 3,485,706 and 3,508,308; the entire content of the aforesaid patents is hereby incorporated by reference herein.

As used herein the term “biodegradable” is meant to represent that a material degrades from the action of naturally occurring microorganisms such as bacteria, fungi, and algae. The biodegradability of a material may be determined using ASTM Test Method D05511-18 for anaerobic biodegradation of plastic material in high-solids anaerobic conditions, ASTM Test Method D5338 for aerobic biodegradation of plastic materials under controlled composting conditions, or ISO CD Test Method 14855 or other suitable and applicable standards. The contents of ASTM Test Method D5511-18, ASTM Test Method D5338 and ISO CD Test Method 14855 are incorporated herein in their entirety by reference.

The word “disposable” is used in the specification to describe laundry articles, such as dryer sheets, that are not intended to be restored or reused as. They are intended to be discarded after a single use and preferably to be disposed of in an environmentally friendly manner.

In general, the present invention is a laundry article, such as a dryer sheet, comprising a water-insoluble substrate onto which one or more treatment compositions is applied.

### Substrate Sheet

In accordance with the present invention, suitable substrate sheets may be obtained from any number of various water-insoluble biodegradable nonwoven fabrics. The term “sheet” refers to a preferred shape of an individual article of the present invention—i.e., a flat sheet that is much greater in width and length than thickness. The flat sheet may be square or rectangular, or any other suitable shape. The substrate may be produced in various ways, for example, by first cutting substrate into small pieces (“sheets”) followed by application of the treatment compositions to these smaller individual sheets. Alternatively, the substrate may be produced by applying treatment compositions to large rolls of substrate and then cutting those coated lengths into individual sheets or pieces.

In accordance with the present invention, the water-insoluble substrate is formed from natural fibers (e.g., 100% organic, natural cellulosic fibers). More specifically, the substrate comprises a non-woven fabric (material) that is formed from natural fibers. Any number of different natural fibers can be used to form the non-woven substrate so long as they are suitable for the intended use described herein. Exemplary natural fibers include but are not limited to, both plant-based natural fibers and animal-based natural fibers. Plant-based natural fibers include, but are not limited to, cotton, hemp, flax, ramie, bamboo, etc. In some embodiments, the substrate may be formed as a blend of two or more of the natural materials. In some embodiments, more than one type of natural fiber may be used to form the substrate.

Cotton is the most widely used natural fiber and is very absorbent, easy to care for, and comfortable for babies. Cotton is almost pure cellulose and is both soft to the touch and advantageously has breathability. As with many materials, cotton is available and marketed in an organic form which is generally understood to mean that the cotton is grown from non-genetically modified plants without the use of any synthetic agricultural chemicals, such as fertilizers or pesticides. In some preferred embodiments of the present technology, the substrate is formed with 100% cotton fiber. In some embodiments, the substrate is formed with a cotton staple fiber (e.g., 2-inch 100% cotton staple fiber), water and air. In some embodiments, no textile agents or additives are used in the manufacture of the cotton substrate.

The nonwoven substrate may be formed by any number of suitable processes including, but not limited to, hydroentanglement, carding, air-laying, thermal treatment, or other suitable processes. In some preferred embodiments, the non-woven substrate is formed by hydroentanglement process. During this process, a selected fiber mixture is dry blended to a homogeneous mixture and transported to a distributor unit while being supported in an air stream. The distributor unit may contain a rotating cylinder or drum that is perforated with holes, slots or other suitable shaped apertures that allow passage of the fibers onto a foraminous carrier. The construction of the drum and configuration and size of the apertures may be adjusted according to the characteristics of the fiber mixture to be employed and to obtain unique web construction. Under the influence of a combination of any of air flow, mechanical agitation within the drum and suction from beneath the carrier, the fibers are directed through the openings of the perforated drum and form a web of homogeneous fiber distribution on the surface of the carrier. The height and degree of matting of the dry web may be varied via control of process variables including fiber content and size, drum aperture size and shape, rate of air flow, degree of suction applied from the bottom of the carrier and carrier speed.

In alternative embodiments, the fibers may be provided as bales with coarsely opened fibers or giber clumps. The fibers are conveyed to the fiber opener, which separates the fibers and lays them spread across on a conveyor to create a mat or a web. This is then conveyed, typically by air, to the carding machine, which is a rotating drum or series of drums covered by card wire (thin strips with teeth). The precise configuration of cards will depend on the type of fiber and the basis weight to be produced. The web can be parallel-laid, where most of the fibers are laid in the machine direction, or they can be randomized. Typical parallel-laid carded webs result in good tensile strength, low elongation and low tear strength in the machine direction and the reverse in the cross direction. Depending on the properties needed, the web then can go through a cross lapper, which layers the carded web on a conveyor, moving at right angles so the fibers are oriented in the cross direction increasing the cross directional strength of the fabric and the web weight, and then, the web will go to a batt drafter machine for further fiber reorientation in machine direction (MD) to obtain a more isotropic and stronger final nonwoven fabric, as well as improved dimensional stability and fiber cohesion. In some cases, the web may go through a secondary carding machine.

Next, the web is transported to a hydroentanglement (spunlacing) system which utilizes rows of highly pressurized water jets to impinge on the fiber web and to mechanically entangle or consolidate the fibers and form the nonwoven web. In one exemplary embodiment, Elevated Air Injection™ system may be used to prepare thew substrate. The higher the pressure of the water as it comes in contact with the fibrous material, the more the fibers will become entangled. High-pressure water can also fracture the fibers, resulting in the formation of micro and nanofibers. A higher rate of entanglement mixed with the occurrence of micro and nanofibers makes for a stronger material, which can be desirable for certain applications. The jets may be oriented perpendicular to the surface of the carrier or angled to provide unique properties to the web. Jets may be placed to consolidate the web from one side or from both the top and bottom side. The pressure of the jets may be from 0.04 bars/kg/h/m to 15 bars/kg/h/m, preferably, 0.1 bars/kg/h/m to 10 bars/kg/h/m, and most preferably 0.3 bars/kg/h/m to 4 bars/kg/h/m. One or more of the drums in the system may have a screen with a desired entangling pattern.

Following the hydroentanglement, the wet nonwoven web may be dried using a combination of mechanical rollers and then passes through a through-air dryer. Once dry, the web goes through a scanning gauge for quality control purposes. The web is wound into a master roll and prepared for further processing, such as application of one or more treatment compounds and/or cutting into desired size sheets.

In some embodiments, multiple airlaid webs may be prepared and stacked prior to spunlacing/hydroentanglement so that thicker nonwoven webs may be produced. Additionally, one or more hydroentangled non-woven layers may be combined to produce a substrate. For example, two or more layers may be combined and entangled to produce the substrate sheet. In preferred embodiments of the technology, the substrate is produced by a process that utilizes only air and water and/or is free or essentially free of any other additives, such as binders, strength additives, and other additives.

In some preferred embodiments, the non-woven sheet contains no binder, adhesive or thermal bonding fibers, and only contains 100% natural cellulosic fibers. In most preferred embodiments, the non-woven sheet contains only 100% cotton fibers. An average length of the individual fibers used to prepare the substrate may be about 0.1 mm to about 100 mm, for example, about 1 mm to about 80 mm, or about 10 mm to about 70 mm, or about 40 mm to about 60 mm.

A basis weight of non-woven webs is usually expressed in ounces of material per square yard (osy) (1 ounce=28.35 grams; 1 yard=0.91 m) or grams per square meter (g/m2). The basis weight of the substrate may be from about 10 g/m2 to about 100 g/m², for example from about 20 g/m² to about 80 g/m², or about 30 g/m² to about 70 g/m², or about 40 g/m² to about 50 g/m2.

In some embodiments, a thickness of the substrate sheet may be around 0.1 mm to around 5 mm, for example around 0.2 mm to around 2 mm, around 0.5 mm to around 1 mm, or around 0.6 mm to around 0.9 mm. The substrate sheet in accordance with the present invention may have a tensile strength of around 17.8 N/5 cm±1.5 N/5 cm in machine direction (MD) and around 7.82 N/5 cm±0.8 N/5 cm in cross direction (CD) as measured by Nonwovens Standard Procedure method NWSP 110.4.R0. The substrate sheet may also have an elongation at break of around 42.7%±2% in MD and around 123%±5% in CD as measured by Nonwovens Standard Procedure method NWSP 110.4.R0.

Pores, a dot matrix, or perforations can be created during the nonwoven formation process or can be applied to the nonwoven after formation. Any number of means can be employed to create these openings in a pre-formed nonwoven, including but not limited to air jet formation, laser formation, during extrusion or casting, or by passing a sheet through a roller mill wherein the rollers have microspikes suitable for forming pores on the sheet. Additionally, a porous sheet can be formed by incorporating microparticles of a water-soluble substance and passing the sheet through a water bath after its formation. The water dissolves the microparticles so as to produce pores. In particularly preferred embodiments, the pores are structurally built during cotton sheet formation, in particular, during the hydroentanglement process. The porous structure of the substrate facilitates the delivery of the treatment composition to the clothes during the drying cycle, as well as achieves a necessary level of loading of the treatment composition onto the substrate.

The openings or pores in the substrate sheet may be any shape that allows the passage of fluid, preferably oval or round. The openings are typically between about 0.1 mm and about 2 mm in diameter. Preferably, the pores of the inner layer are about 0.5 mm to about 1 mm in diameter. Most preferably, the pores are about 0.7 mm in diameter.

The substrate material is cut into individual dryer sheets which may have any desirable shape, such as rectangular, square, etc. In some embodiments, each individual sheet has a length of about 100 mm-300 mm, or about 150 mm-250 mm, or about 200 mm, and a width of about 60-260 mm, or about 100-200 mm, or about 160 mm. Each individual dryer sheet has a weight of about 0.5 g-2.5 g, or about 1 g-2 g, or about 1.3 g-1.5 g.

### Treatment Composition

After the non-woven substrate is formed by any of the suitable processes described above, one or more treatment compositions are applied to the substrate. The treatment compositions in accordance with the present invention only include natural or plant-based ingredients that are biodegradable, as discussed in more detail below. The treatment composition is applied to the substrate at about 50% to about 150% by weight. In some embodiments, about 80% to about 120% by weight of the treatment is applied. In certain of those embodiments, about 100% by weight of the treatment is applied to achieve about 1:1 loading by weight. In some embodiments, a weight of each individual substrate sheet is around 1 g-2 g, or around 1.3 g-1.5 g, and a weight of the treatment composition applied to each individual substrate sheet is around 0.5 g-1.5 g, or around 0.8 g-1.2 g, or around 0.9 g, or around 1.2 g.

As used herein, the terms “percent”, “%,” “weight percent” and “wt %” all mean the percentage by weight of the indicated component or ingredient within the product or composition in which it is present, without dilution, unless otherwise indicated by the context in which the term is used. When the treatment is applied to a fabric, the percent”, “%,” “weight percent” and “wt %” refers to the amount applied to the fabric upon drying unless otherwise stated. Treatment solutions and suspensions comprise various percentages by weight of the treatment compositions in water unless another solvent/diluent is indicated.

The treatment composition may be applied to the substrate sheet by any suitable method. In exemplary preferred embodiments, the treatment composition remains with the substrate sheet until a certain release temperature is reached during the drying cycle, after which the treatment composition is transferred to the laundry items being dried to impart the desired characteristics to the items (softening, antistatic, fragrance, etc.). The release temperature may be around 100-150 degrees F, e.g., from around 110 to around 130 degrees F. In some embodiments, the treatment composition may be coated onto one or both sides of the substrate sheet by spraying and subsequent drying, or another suitable method. In additional embodiments, the treatment composition may be impregnated into the substrate sheet by soaking or another suitable method, and then dried. In further embodiments of the present technology, the treatment composition may be applied in two or more steps. For example, a first treatment composition may be applied onto the substrate first and dried, followed by application of a second treatment composition over the first composition and subsequent drying to produce a finished dryer sheet. In some exemplary preferred embodiments, a first treatment composition comprising a softener and an antistatic agent (as discussed in more detail below) is sprayed onto the substrate and dried, and then, a second treatment composition comprising a stabilizer and optionally, a fragrance (as discussed in more detail below) is sprayed and dried.

In various embodiments of the present technology, the treatment compositions include at least one of softening agent, antistatic agent, antiwrinkle agent and fragrance.

Various biodegradable softeners and antistatic agents may be used in the treatment composition. Examples of suitable softeners and antistatic agents include, but are not limited to, plant-based cationic surfactants, fatty acid derivatives, lecithin-based agents, polysaccharide-based agents, and natural waxes and oils.

Plant-based cationic surfactants are derived from plant-based fatty acids and neutralize static electricity, as well as provide fabric softening qualities. Suitable examples include ester quats, such as triethanolamine quat (plant-based quaternary ammonium), and fatty acid based surfactants. In some preferred embodiments, ester quats of sunflower or olive oil may be used, such as triethanol ammonium alkyl diester methyl sulfate. In additional embodiments, fatty acids of palm oil may be used, such as dipalmitoylethyl hydroxyethylmonium methosulfate. Ester quats are notable for excellent biodegradability. It may be preferred that the plant-based cationic surfactant is a fabric softening agent. It may also be preferred that the plant-based cationic surfactant is an anti-static agent. The cationic surfactants may be present in an amount of about 5% to about 50% by weight of the treatment composition, or about 10% to about 40% by weight of the treatment composition, or about 20% to about 30% by weight of the treatment composition.

Fatty acid-based softeners work by coating fabrics with a thin, soft layer and preventing static build-up. Plant-based fatty acid based softeners are derived from plant-based fatty acids. Examples of various suitable plant-based fatty acid-based agents include fatty acid based oils, such as coconut oil, palm oil, vegetable oil, geranium oil, moringa oleifera seed oil, brassica oil, coconut palm oil, and palm kernel oil, fatty acid esters, and fatty alcohols. Examples of suitable plant-based fatty alcohol softeners include, but are not limited to, cetyl alcohol, stearyl alcohol, cetearyl alcohol, and Ceteareth-20. Other suitable plant-based fatty acid agents include isononanoic acid, C16-18-alkyl esters, glyceryl stearate, and cetyl palmitate. The fatty-acid based softeners may be present in an amount of about 5% to about 50% by weight of the treatment composition, or about 10% to about 40% by weight of the treatment composition, or about 20% to about 30% by weight of the treatment composition.

The treatment composition may also include natural waxes and oils, which provide softening while being fully biodegradable. Some examples include soybean oil derivatives, jojoba oil esters, and carnauba wax. Further, the treatment composition may include polysaccharide-based softeners, guar gum derivatives and chitosan derived from shellfish or fungi.

In some embodiments, the treatment composition may also include one or more biodegradable diluents. Diluents assist in dissolving, diluting or carrying of active ingredients (like softeners, antistatic agents, fragrances, and conditioning agents) more effectively. Diluents may be solvents or carriers that help spread and distribute other ingredients evenly across the substrate sheet. Examples of suitable diluents include, but are not limited to, vegetable oils such as soybean oil, coconut oil and sunflower oil, plant-based alcohols such as propanediol, isopropyl alcohol and ethanol, vegetable glycerin, plant-based waxes such as candelilla was and carnauba wax, plant-based sugars such as xylitol and sucrose, plant-based gums such as guar gum and xanthan gum, and plant-based hydrosols. In some preferred embodiments, propanediol and ethanol may be used as diluents. The diluents may be present in an amount of about 5% to about 60% by weight of the treatment composition, or about 10% to about 50% by weight of the treatment composition, or about 20% to about 40% by weight of the treatment composition.

The treatment composition may include one or more plant-based pH control agents, which assist in maintaining the desired pH balance, ensure product stability and optimal performance for fabric softening, fragrance release, and anti-static effects. Examples of suitable pH control agents include, but are not limited to, citric acid, lactic acid, tartaric acid, malic acid, gluconic acid, and acetic acid. In some preferred embodiments, lactic acid is used. The pH control agents may be present in an amount of about 0.01% to about 10% by weight of the treatment composition, or about 0.1% to about 1% by weight of the treatment composition, or about 0.5% by weight of the treatment composition. In some embodiments, the treatment composition has a pH of about 3 to about 6, or about 3.2 to about 5.4, or about 4.6.

The treatment composition may include other biodegradable agents, including but not limited to, emollients such as vegetable oils and fatty alcohols, fillers and bulking agents such as cellulose, starch, and clay, wetting agents such as propylene glycol and glycerin, plant-based biodegradable preservatives, plant-based colorants, and stabilizers and thickeners such as xanthan gum and guar gum.

In some exemplary embodiments, the treatment composition is unscented. In other exemplary embodiments, the treatment composition comprises one or more fragrances. It is preferred that the fragrances are plant-based and/or biodegradable, such as essential oils, plant extracts and/or plant-based isolates. Examples of suitable plant-based fragrance agents include, but are not limited to, cedarwood oil, evergreen leaves extract (pentyl salicylate), rose, carnation, hyacinth, and orange blossom extract (2-phenylethanol), violet flower, melon and blueberry extract (piperonal), and lavender, tonka bean and cinnamon extract (coumarin). When present, the fragrances may be provided in an amount of about 1% to about 40% by weight of the treatment composition, or about 5% to about 30% by weight of the treatment composition, or about 10% to about 20% by weight of the treatment composition.

In preferred embodiments, the treatment composition is free or essentially free of water, e.g., water is not used as a solvent for the treatment composition.

### Application of Treatment Composition to Substrate Sheet

One the master roll of substrate material is prepared, the treatment composition is applied to the substrate material via any suitable method. The treatment composition provides the softening, anti-static, anti-wrinkle, and fragrance properties to the substrate.

The treatment composition is a quaternary solution made with natural and biodegradable ingredients with thick, viscose, and waxy characteristics. To be able to apply it, the composition temperature needs to be above about 36 °C to get the right fluid viscosity. The composition temperature should not exceed about 60 °C or it will degrade and loose its properties.

The treatment composition may be applied in a single phase or a two-phase process depending on the chemical characteristics and compatibility between the base quaternary solution and the fragrance components of the treatment composition.

The single-phase treatment composition includes the softener, anti-static, anti-wrinkle, fragrance and binder agents all in one fluid. The single-phase composition may be applied to the substrate in about 1:1 treatment composition to substrate weight ratio.

The two-phase treatment composition includes two fluids. The first fluid includes the softener, anti-static and anti-wrinkle agents and it is applied to the substrate in about 0.9:1 treatment composition to substrate weight ratio. The second fluid has the fragrance and a binder and is subsequently applied to the substrate in about 0.1:1 treatment composition to substrate weight ratio. Fragrance used in the second phase composition may be a heavy molecular fragrance such that it can attach to the first phase composition without it being anchored to it and be able to be released from the dryer sheet and attached to the clothes during the drying process.

One exemplary method for applying a treatment composition to the substrate sheet is as follows. First, a container containing the treatment composition is heated, for example in a hot bath, to get it to the right temperature and viscosity suitable to transfer the treatment composition from the container into a pressurized metal tank. The tank is also preferably kept in a hot water bath to maintain the application temperature. The treatment composition may be fed into a pump, such as a centrifugal pump, kinetic pump, positive displacement pump, axial pump, screw pump, peristaltic pump, piston pump or a gear pump for subsequent application to the dryer sheet substrate.

The substrate sheet web is then pass through a treatment composition application equipment which, depending on the treatment composition type (single phase or two-phase), may be one or a combination of the following types of equipment.

Spray Head and Nozzle Equipment: The treatment composition fluid is delivered from the tank via a pump (as outlined above) or a pressurized system through hoses that are connected to a spray head with a nozzle. Temperature control throughout the system is critical, including a heated pressure air source, for an even spray application onto the substrate and minimization of residual surfactant release into the environment. In some embodiments, the operational temperature range is from about 40 degrees C to about 50 degrees C.

Dip and Nip Equipment: The treatment composition fluid is poured into a temperature-controlled tray with a roller positioned on top of the tray and dipped in the fluid. The substrate sheet will then partially wrap around the part of the roller that is dipped in the fluid, then is pulled out and passed between a set of nip rolls that will remove the excess fluid.

Spray and Contact Bar Equipment: The treatment composition fluid is delivered via a pressurized and temperature-controlled hose connected to a metal bar that has a single line of evenly distributed perforations. The substrate will pass at a distance of about 5 mm to about 10 mm and at about 30° to 60° angle in front of the perforated bar such that the fluid gets sprayed and then partially wrap around a roller which will help the fluid penetrate and set onto the substrate.

Parabolic Foaming Equipment: The treatment composition fluid is delivered via a pressurized and temperature-controlled hose connected to a parabolic metal bar that has a single line of evenly distributed perforations. The substrate will partially wrap around the bar and the fluid is foamed onto the substrate.

With all of the above-described types of equipment, a set of air nozzles may be provided after the application equipment that blow air onto the substrate to help the treatment composition to set onto the substrate. The substrate with the treatment composition is then wound onto a master roll that will be set aside and left to cure for about 2 to about 4 hours.

A master roll treated with a single-phase treatment composition is then ready to be transferred to a station where it will be cut to desired dimensions and then transferred to a machine that will “Z” fold the substrate, cut it to the desired dimensions, stack the sheets and transfer the stack to a flowrap section to be packaged.

A master roll treated with the first of the two-phase treatment composition is set aside and left to cure for about 2 to about 4 hours and then returned to the machine to apply the second phase treatment composition, then left aside for about 2 to about 4 hours to cure and finally sent to the “Z” fold, cut and stack operation.

### EXAMPLES

Example 1—Scented Dryer Sheet: Non-woven substrate (100% cotton fibers). The treatment composition has the following formulation (listed by weight percentages of the total weight of the treatment composition):

| Ingredient | % w/w |
|---|---|
| Plant-derived cationic surfactants | 28.5% |
| (as antistatic/softener agents) | |
| Plant-derived fatty alcohols (as | 23% |
| softener agents) | |
| pH regulator | 0.5% |
| Plant-derived diluents | 36% |
| Binder with Fragrance | 12% |

The treatment composition is prepared and applied to the non-woven substrate by the two-phase method described above.

Example 2—Unscented Dryer Sheet: Non-woven substrate (100% cotton fibers). The treatment composition has the following formulation (listed by weight percentages listed by weight percentages of the total weight of the treatment composition):

| Ingredient | % w/w |
|---|---|
| Plant-derived cationic surfactants | 28.5% |
| (as antistatic/softener agents) | |
| Plant-derived fatty alcohols (as | 23% |
| softener agents) | |
| pH regulator | 0.5% |
| Plant-derived diluents | 36% |
| Binder | 12% |

The treatment composition is prepared and applied to the non-woven substrate by the one-phase method described above.

The biodegradable dryer sheets of the present invention may satisfactorily pass at least one of ASTM Test Method D5511, ASTM Test Method 5338, ASTM Test Method D6400, and ISO CD Test Method 14855. AST D5511 is a standard test method for determining anaerobic biodegradation of plastic materials under high-solids anaerobic-digestion conditions. ASTM D6400 is a standard specification for labeling of plastics designed to be aerobically composted in municipal or industrial facilities. ASTM 5338 is a standard test method for determining aerobic biodegradation of plastic materials under controlled composting conditions incorporating thermophilic temperatures.

Additionally, biodegradable dryer sheets of the present invention are hypoallergenic and may satisfactorily pass the 100 subjects Human Repeat Insult Patch Test (HRIPT). HRIPT is a clinical study used to assess the potential for irritation, sensitization, and allergic contact dermatitis of a product by repeatedly exposing volunteers to the product on their skin. Dryer sheet patches are repeatedly applied to the backs of volunteers for a specific period (induction phase-usually 6 weeks). After the induction phase, there is a rest period (typically 2 weeks) to allow the body to potentially develop sensitization. The product is then reapplied to a new site on the subject's skin to determine if a repeat application will elicit an allergic reaction, indicating sensitization has occurred.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A disposable dryer sheet comprising:
a non-woven substrate comprising 100% cotton;
a bio-degradable treatment composition applied to the non-woven substrate comprising at least one of a softening agent, an antistatic agent, an antiwrinkle agent, a fragrance, and a binder.

2. The disposable dryer sheet of claim 1, wherein the treatment composition is applied to at least one of a top surface or the bottom surface of the substrate.

3. The disposable dryer sheet of claim 1, wherein the treatment composition is impregnated into the substrate.

4. The disposable dryer sheet of claim 1, wherein the substrate includes a plurality of pores.

5. The disposable dryer sheet of claim 1, wherein the substrate consists of 100% cotton spunlaced fibers.

6. The disposable dryer sheet of claim 1, wherein the substrate is essentially free from spunbond and meltblown fibers.

7. The disposable dryer sheet of claim 1, wherein the treatment composition is applied to the substrate at a weight ratio of about 1:1.

8. The disposable dryer sheet of claim 1, wherein the treatment composition comprises at least one softening agent selected from the group consisting of biodegradable cationic surfactants, biodegradable fatty alcohols and mixtures thereof.

9. The disposable dryer sheet of claim 1, wherein the treatment composition further comprises at least one biodegradable diluent.

10. The disposable dryer sheet of claim 1, wherein the treatment composition further comprises at least one biodegradable pH control agent.

11. The disposable dryer sheet of claim 1, wherein the treatment composition is essentially free of water.

12. The disposable dryer sheet of claim 1, wherein the treatment composition comprises:
from about 20% to about 40% by weight of at least one cationic surfactant;
from about 20% to about 30% by weight of at least one fatty alcohol;
from about 25% to about 45% by weight of at least one diluent; and
from about 5% to about 20% by weight of at least one fragrance and binder.

13. The disposable dryer sheet of claim 1, wherein the treatment composition comprises:
from about 20% to about 40% by weight of at least one cationic surfactant;
from about 20% to about 30% by weight of at least one fatty alcohol; and
from about 25% to about 45% by weight of at least one diluent.

14. The disposable dryer sheet of claim 1, wherein the disposable dryer sheet passes at least one of ASTM 05511, ASTM 5338, and ASTM D6400.

15. The disposable dryer sheet of claim 1, wherein the treatment composition is a single-phase composition comprising a softener, an anti-static agent, an anti-wrinkle agent, a fragrance and a binder, wherein the single-phase composition is applied to the non-woven substrate in a single step.

16. The disposable dryer sheet of claim 1, wherein the treatment composition is a two-phase composition comprising:
a first phase composition comprising a softener, an anti-static agent and an anti-wrinkle agent, and
a second phase composition comprising a fragrance and a binder,
wherein the first phase composition and the second phase composition are sequentially applied to the non-woven substrate, and
wherein the first phase composition is applied to the substrate at a weight ratio of about 0.9:1 and the second phase composition is applied to the substrate at a weight ratio of about 0.1:1.

17. A method of manufacturing a disposable dryer sheet, comprising the steps of:
preparing a non-woven substrate comprising 100% cotton by a spunlacing process;
preparing a bio-degradable treatment composition comprising at least one of a softening agent, an antistatic agent, an antiwrinkle agent, a fragrance, and a binder;
applying the treatment composition to the non-woven substrate; and
cutting the non-woven substrate into individual dryer sheets.

18. The method of claim 17, wherein the treatment composition is a two-phase composition comprising:
a first phase composition comprising a softener, an anti-static agent and an anti-wrinkle agent, and
a second phase composition comprising a fragrance and a binder; and
wherein the step of applying the treatment composition to the non-woven substrate comprises the steps of:
applying the first phase composition to the non-woven substrate and curing the substrate; and
applying the second phase composition to the non-woven substrate and curing the substrate.

19. The method of claim 17, wherein the treatment composition is a single-phase composition comprising a softener, an anti-static agent, an anti-wrinkle agent, a fragrance and a binder, wherein the treatment composition is applied to the non-woven substrate in a single step.
